(19) United States
(12) Patent Application Publication
(10) Pub. No.: US 2016/0283592 A1
(43) Pub. Date: Sep. 29, 2016

(54) METHOD FOR PERFORMING NETWORK SEARCH AT A BROWSER SIDE AND A BROWSER

(71) Applicant: BEIJING QIHOO TECHNOLOGY COMPANY LIMITED, Beijing (CN)

(72) Inventors: Yufeng MI, Beijing (CN); Lin LI, Beijing (CN)

(21) Appl. No.: 15/034,940

(22) PCT Filed: Sep. 24, 2014
(86) PCT No.: PCT/CN2014/087292

§ 371 Date: May 6, 2016

(30) Foreign Application Priority Data
Nov. 8, 2013 (CN) 201310554095.7

(51) Int. Cl. G06F 17/30

(52) U.S. Cl. CPC G06F 17/30864; G06F 17/30554; G06F 17/30887

(57) ABSTRACT

The invention provides a method for performing network search at a browser side and a browser. The method for performing network search at a browser side comprises the following steps: acquiring in a current page a webpage element for which a search operation is to be performed; determining a webpage element type of the webpage element and a search type corresponding to the webpage element type; acquiring a search keyword of the webpage element; and initiating a search request to a search engine corresponding to the search type according to the search keyword, and displaying a returned search result at the browser side. By applying the solution, the search result displayed in the browser matches the webpage element type, the result obtained by a user more meets search expectations, intervention of the search procedure by the user is reduced, and the efficiency of the search operation performed by the user when browsing a webpage is improved.

### FIELD OF THE INVENTION

The invention relates to the field of internet, and in particular, to a method for performing network search at a browser side and a browser.

### BACKGROUND OF THE INVENTION

Traditional network search methods lie in that, a user opens a page of a search engine, enters a keyword in an input box or other interface in the page and initiates search, and then the search result is loaded in a page of a website of the search engine. By utilizing a traditional search method, when a user needs to search a text of a webpage when browsing the webpage, he first copies the corresponding text, then opens a page of a search engine and enters the text, so as to be able to perform search. The operation steps of the user are relatively complex.

In addition, there is further a search method in the prior art, in which a user selects part of words from the content currently browsed, a quick search button will appear in the browser, and after the user clicks the button, it may jump to a search result page of the search engine according to the selected words, and the search result page will be exhibited in a new page.

FIG. 1 and FIG. 2 show two effect drawings of a browser launching webpage quick search in the prior art, respectively. As shown in the figures, after a user selects a text, once a preset condition is satisfied, for example, a mouse stays at the selected word for a predetermined time, or the like, a quick search button will be displayed at the selected word, so that the user operates. However, existing zoned word quick search lies in, based on word information obtained after the selection, producing a pre-configured entry option, directly loading an icon of the entry and generating a corresponding uniform resource locator (URL for short). In such a mode, the entry of the search is fixed, and much search content that the user does not need, which can not meet the requirements of targeted search of the user. In addition, after the user clicks the button, the page directly jumps to the label of the search result, which interrupts the user's browsing in the original page.

### SUMMARY OF THE INVENTION

In view of the above problems, the invention is proposed to provide a browser and a corresponding method for performing network search at a browser side, which overcome the above problems or at least in part solve the above problems.

According to an aspect of the invention, there is provided a method for performing network search at a browser side. The method for performing network search at a browser side comprises the following steps: acquiring in a current page a webpage element for which a search operation is to be performed; determining a webpage element type of the webpage element and a search type corresponding to the webpage element type; acquiring a search keyword of the webpage element; and initiating a search request to a search engine corresponding to the search type according to the search keyword, and displaying a returned search result at the browser side.

Optionally, the determining a webpage element type of the webpage element comprises: determining a type of the webpage element according to a uniform resource locator comprised in a hypertext markup language text.

Optionally, the determining a type of the webpage element according to the uniform resource locator comprised in the hypertext markup language text comprises: searching for a filename extension comprised in the uniform resource locator; and judging out the webpage element type by the filename extension.

Optionally, the acquiring a search keyword of the webpage element comprises: searching the hypertext markup language text for the description information of the webpage element as the search keyword; or extracting the description information of the webpage element as the search keyword by traversing DOM data nodes of the page.

Optionally, the determining a search type corresponding to the webpage element type comprises: searching for one or more search type corresponding to the webpage element type from a preset mapping configuration table.

Optionally, there are multiple search types corresponding to the webpage element type, the initiating a search request to a search engine corresponding to the search type according to the search keyword comprises: assigning weights to the multiple search types according to priority levels, and initiating a search request to multiple search engines corresponding to the search types according to the search keyword in the order of the weights, respectively; and the displaying a returned search result at the browser side comprises: displaying search results returned by the multiple search engines at the browser side in the order of the weights.

Optionally, the displaying a returned search result at the browser side comprises: generating in the page an exhibition floating layer classified according to the search type, and loading the search result in the floating layer.

Optionally, the acquiring in a current page a webpage element for which a search operation is to be performed comprises: acquiring the webpage content selected by a user from the page, and obtaining from the selected webpage content the webpage element for which a search operation is to be performed.

Optionally, the webpage element type comprises any one or more of the following: video, picture, music, and word.

According to another aspect of the invention, there is provided a browser. The browser comprises: a webpage element acquisition module configured to acquire in a current page a webpage element for which a search operation is to be performed; a type determination module configured to determine a webpage element type of the webpage element and a search type corresponding to the webpage element type; a keyword acquisition module configured to acquire a search keyword of the webpage element; and a search interface configured to initiate a search request to a search engine corresponding to the search type according to the search keyword, and display a returned search result at the browser side.

Optionally, the type determination module is configured to acquire a hypertext markup language text corresponding to the webpage element; and determine a type of the webpage element according to a uniform resource locator comprised in the hypertext markup language text.

Optionally, the keyword acquisition module is configured to search the hypertext markup language text for the description information of the webpage element as the search keyword; or extract the description information of the webpage element as the search keyword by traversing DOM data nodes of the page.

Optionally, the type determination module is further configured to search for one or more search type corresponding to the webpage element type from a preset mapping configuration table.

Optionally, there are multiple search types corresponding to the webpage element type, and the search interface is configured to assign weights to the multiple search types according to priority levels, and initiate a search request to multiple search engines corresponding to the search types according to the search keyword in the order of the weights, respectively; and display search results returned by the multiple search engines at the browser side in the order of the weights.

Optionally, the browser further comprises: a display module configured to generate in the page an exhibition floating layer classified according to the search type, and load the search result in the floating layer.

Optionally, the webpage element acquisition module is configured to acquire the webpage content selected by a user from the page, and obtain from the selected webpage content the webpage element for which a search operation is to be performed.

According to yet another aspect of the invention, there is provided a computer program comprising a computer readable code which causes a computing device to perform any of the methods for performing network search at a browser side described above, when said computer readable code is running on the computing device.

According to still another aspect of the invention, there is provided a computer readable medium storing therein the computer program as described above.

In the method for performing network search and the browser of the invention, since a webpage element is acquired for which a search operation needs to be performed, and a search type and a keyword are determined according to the webpage element, the search result displayed in the browser matches the webpage element type, the result obtained by a user more meets search expectations, intervention of the search procedure by the user is reduced, and the efficiency of the search operation performed by the user when browsing a webpage is improved.

Further, in the invention, an exhibition floating layer classified according to the search type is generated in the page, and the search result is loaded in the floating layer, which can perform display according to an accurate classification, facilitates the user to quickly obtain the search result, and does not affect the user's browsing the original page.

The above description is merely an overview of the technical solutions of the invention. In the following particular embodiments of the invention will be illustrated in order that the technical means of the invention can be more clearly understood and thus may be embodied according to the content of the specification, and that the foregoing and other objects, features and advantages of the invention can be more apparent.

### BRIEF DESCRIPTION OF THE DRAWINGS

Various other advantages and benefits will become apparent to those of ordinary skills in the art by reading the following detailed description of the preferred embodiments. The drawings are only for the purpose of showing the preferred embodiments, and are not considered to be limiting to the invention. And throughout the drawings, like reference signs are used to denote like components. In the drawings:

FIG. 1 shows a first effect drawing of a browser launching webpage quick search in the prior art;

FIG. 2 shows a second effect drawing of a browser launching webpage quick search in the prior art;

FIG. 3 is a schematic diagram of a browser according to an embodiment of the invention;

FIG. 4 is a schematic diagram of a method for performing network search at a browser side according to an embodiment of the invention;

FIG. 5 is a flow chart of a method for performing network search at a browser side according to an embodiment of the invention;

FIG. 6 is an effect drawing in which a search result is exhibited in a floating layer in a method for performing network search at a browser side according to an embodiment of the invention;

FIG. 7 shows schematically a block diagram of a computing device for performing a method for performing network search at a browser side according to the invention; and

FIG. 8 shows schematically a storage unit for retaining or carrying a program code implementing a method for performing network search at a browser side according to the invention.

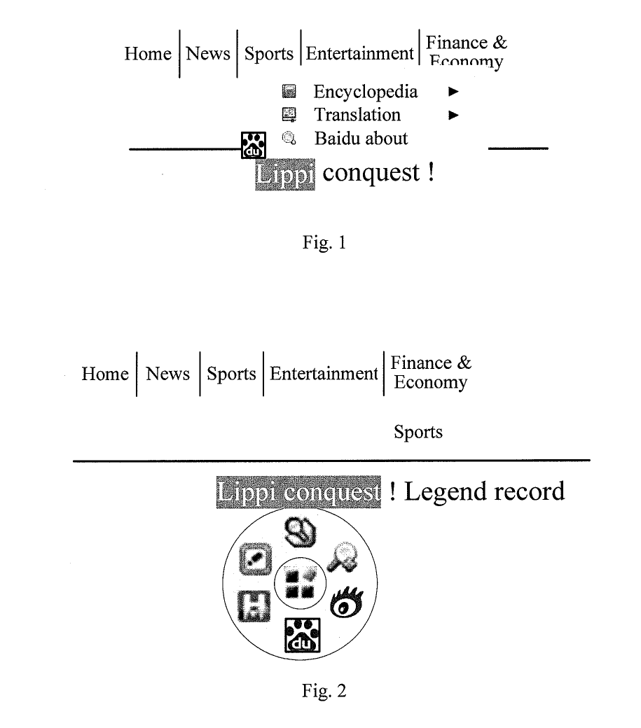

### DETAILED DESCRIPTION OF THE INVENTION

In the following the invention will be further described in connection with the drawings and the particular embodiments.

The algorithms and displays provided here are not inherently related to any specific computer, virtual system or other device. Various general-purpose systems may also be used with the teachings herein. According to the above description, the structure required for constructing such systems is obvious. In addition, the invention is not directed to any specific programming language. It should be understood that the content of the invention described herein may be carried out utilizing various programming languages, and that the above description for a specific language is for the sake of disclosing preferred embodiments of the invention.

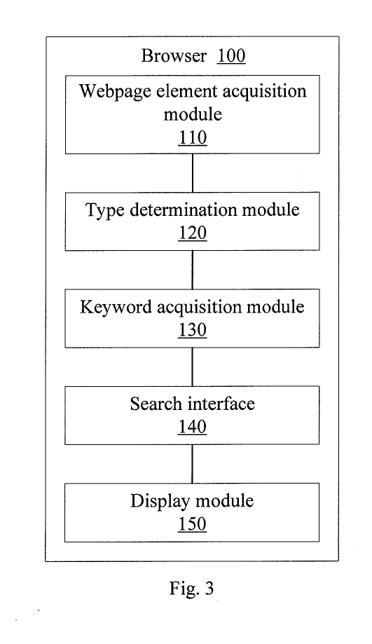

FIG. 3 is a schematic diagram of a browser 100 according to an embodiment of the invention. The browser 100 may generally comprise: a webpage element acquisition module 110, a type determination module 120, a keyword acquisition module 130, a search interface 140 and a display module 150.

In the browser 100, the webpage element acquisition module 110 is configured to acquire in a current page a webpage element for which a search operation is to be performed. Its work flow may be configured to acquire the webpage content selected by a user from the page, and obtain from the selected webpage content the webpage element for which a search operation is to be performed, for example, acquire the content zoned by a user using a mouse or selected on a touch screen.

The type determination module 120 is configured to determine a webpage element type of the webpage element and a search type corresponding to the webpage element type. Therein, the webpage element type of the webpage element may be obtained by a hypertext markup language (HTML for short) text of the page. A flow of determining a webpage element type of the webpage element may be to acquire a hypertext markup language text corresponding to the webpage element, and determine a type of the webpage element according to a uniform resource locator (URL for short) comprised in the hypertext markup language text. For a URL comprising an extension field, it may be possible to search for the filename extension comprised in the uniform resource locator, and judge out the webpage element type by the filename extension. For example, JPG corresponds to a picture type, avi corresponds to a video type, and mp3 corresponds to a music type.

In the case in which the webpage element type is determined, each webpage element corresponds to one or more search type. For example, a picture-typed webpage element corresponds to picture-typed search, a music-typed webpage element corresponds to music-typed search, a video-typed webpage element corresponds to video-typed search, and a program-typed webpage element corresponds to program-typed search. The mapping relationship from webpage elements to search types may be configured by presetting a configuration table and according to settings of a user or a browser developer. A search type corresponding to a webpage element type and a search engine corresponding to the search type are recorded in the configuration table, for example, a video webpage element will correspond to four video search entries of the Baidu video, the 360 video, the Google video, and the Soku video, and for search of other webpage element types, it may also be possible to configure the entries corresponding to them.

The keyword acquisition module 130 is configured to acquire a search keyword of the webpage element. The acquisition flow of the keyword acquisition module 130 may be configured as the following two modes: one is to search the HTML text for the description information of the webpage element as the search keyword; or extract the description information of the webpage element as the search keyword by traversing DOM data nodes of the page. After the user zones the webpage element, the browser will traverse nodes of a DOM tree of the webpage to acquire a keyword in a node close to the selected webpage element, especially a page title, and select descriptive words close to the webpage element, for example, if the type of the selected webpage element is picture, it may be possible to search descriptive words of pictures for a search keyword.

The search interface 140 is configured to initiate a search request to a search engine corresponding to the search type according to the search keyword, and display the returned search result at the browser side. In a case in which there are multiple determined search types, the search interface 140 may assign weights to the multiple search types according to priority levels, initiate a search request to multiple search engines corresponding to the search types according to the search keyword in the order of the weights, respectively, and display the search results returned by the multiple search engines at the browser side in the order of the weights.

The display module 150 is configured to generate in the page an exhibition floating layer classified according to the search type, and load the search result in the floating layer, which can hereby perform display according to an accurate classification, facilitates the user to quickly obtain the search result, and does not affect the user's browsing the original page.

The webpage element type in the webpage content selected from the page by the user comprises any one or more of the following: video, picture, music, and word. For video, picture and music, the search target of the user is relatively clear, and in a matching mapping table of webpage elements and search types, multiple corresponding search engines may be preset. In a case of searching the selected webpage word, since they may correspond to various search types, the browser 100 in this embodiment may load all the search types, or after sorting is performed according to frequencies with which the user uses the search types, search according to the sorting result and load.

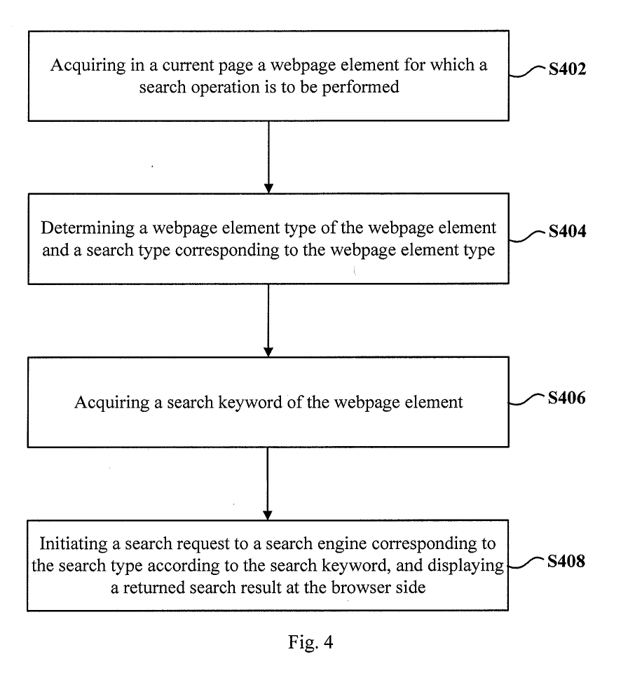

An embodiment of the invention further provides a method for performing network search at a browser side. The method for performing network search at a browser side may be implemented by any of the browsers introduced in the above embodiments, to obtain a search result better matching the user's selection. FIG. 4 is a schematic diagram of a method for performing network search at a browser side according to an embodiment of the invention. The method for performing network search at a browser side may generally comprise the following steps:

step S402, acquiring in a current page a webpage element for which a search operation is to be performed;

step S404, determining a webpage element type of the webpage element and a search type corresponding to the webpage element type;

step S406, acquiring a search keyword of the webpage element; and

step S408, initiating a search request to a search engine corresponding to the search type according to the search keyword, and displaying a returned search result at the browser side.

By implementing the method of this embodiment, a way of quick search at the browser side according to selected content is achieved, and the eventually obtained search result is obtained from a search engine corresponding to the content selected by the user, and is more consistent and more accurate.

The step S402 may acquire the webpage content selected from the page by a user, and obtain from the selected webpage content the webpage element for which a search operation is to be performed, for example, acquire the content zoned by a user using a mouse or selected on a touch screen.

The flow of determining a webpage element type at the step S404 may comprise: determining a type of the webpage element according to a uniform resource locator URL comprised in a hypertext markup language HTML text. The webpage element type may be determined by utilizing a filename extension in the URL, and the flow may be to search for the filename extension comprised in the uniform resource locator URL, and judge out the webpage element type by the filename extension. For example, JPG corresponds to a picture type, avi corresponds to a video type, and mp3 corresponds to a music type. The webpage element type comprises any one or more of the following: video, picture, music, and word.

The flow of determining a search type corresponding to the webpage element type at the step S404 may comprise: searching for one or more search type corresponding to the webpage element type from a preset mapping configuration table.

The flow of the step S406 may be implemented by the two modes: searching the hypertext markup language text for the description information of the webpage element as the search keyword; or extracting the description information of the webpage element as the search keyword by traversing DOM data nodes of the page. For example, after the user zones the webpage element, the browser will traverse nodes of a DOM tree of the webpage to acquire a keyword in a node close to the selected webpage element, especially a page title, and select descriptive words close to the webpage element, extracts them and then display them to the user for selection so as to obtain a search keyword, or also may perform logic processing such as AND-OR, etc. to generate a search formula conforming to a search specification for searching, and after determined by the user, generate a search request based on a certain search type and search keyword here.

In a case in which there are multiple search types corresponding to the webpage element type, the flow of the step S408 may be to assign weights to the multiple search types according to priority levels, initiate a search request to multiple search engines corresponding to the search types according to the search keyword in the order of the weights, respectively, and display search results returned by the multiple search engines at the browser side in the order of the weights. Therein, the displaying the returned search result at the browser side comprises: generating in the page an exhibition floating layer classified according to the search type, and loading the search result in the floating layer.

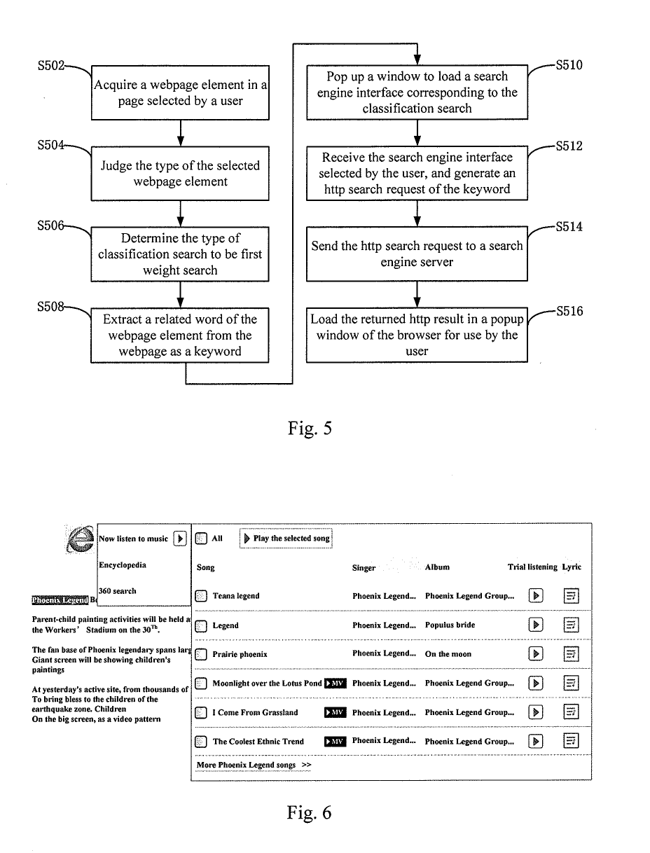

FIG. 5 is a flow chart of a method for performing network search at a browser side according to an embodiment of the invention. The implementation of the method is triggered by the content of the page zoned by the user, and the flow comprises the following steps.

At step S502, a webpage element in a page selected by a user is acquired. Acquisition of a webpage element may be implemented by the interface IHTMLSelectionObject, and the flow may be to, first obtain a pointer of the interface IHTMLSelectionObject according to the pointer IHTMLDocument2, then obtain the pointer ITxtRange, get the selected html text content, and get the selected text content.

At step S504, the type of the selected webpage element is judged. The webpage element may be a webpage word, a picture, music (or its corresponding URL is a music type), a video (or its corresponding URL is a video type), or a program (or its corresponding URL is an APP download address or the name of a program installation package). Therein, the word may further correspond to quite a few possible search types: news, webpage, quiz, music, encyclopedia, map, shopping, and good doctor. A judgment mode may employ a way of judging whether a URL is comprised in bstrHtmlTxt. If a URL is comprised, a filename extension comprised in the URL is obtained. The search type is judged according to the filename extension. For example, JPG corresponds to a picture type, avi corresponds to a video type, and mp3 corresponds to a music type.

At step S506, the type of classification search is determined to be first weight search; a webpage element type corresponds to a search type, for example, a picture-typed webpage element corresponds to picture-typed search, a music-typed webpage element corresponds to music-typed search, a video-typed webpage element corresponds to video-typed search, and a program-typed webpage element corresponds to program-typed search; or the determined search type is displayed preferentially as a search type of the first weight, and the search result is requested to be returned for display. Other search type is loaded as a search item of a second weight (e.g., the first weight is video, and the second weight is determined to be a webpage word, or encyclopedia according to a keyword in the content of the current webpage), and it is not until the user performs a click that a search request is initiated and the search result is acquired. For the mapping relationship from webpage elements to search types, a configuration table may be saved according to the settings of the user or the browser developer.

Further, one type in the configuration table may correspond to multiple search engines, for example, a video category will correspond to four video search entries of the Baidu video, the 360 video, the Google video, and the Soku video, and for search of other types, it may also be possible to configure the entries corresponding to them. The user may further load a corresponding result after selection of an entry, and if the user does not select, an entry of, e.g., the 360 video will be selected by default.

At step S508, a related word of the webpage element is extracted from the webpage as a keyword; and the keyword may be field information generated by utilizing bstrHtmlTxt, for example, for pictures, after a picture is selected, the search keyword may be acquired from the picture introduction word aside it. Since the webpage element of the word may correspond to various search types, it may be possible to load all the search types or select a search type which is used by the user with a high frequency when processing.

At step S510, a window is popped up to load a search engine interface corresponding to the classification search, wherein for a keyword of the content description information of a picture, a keyword of the name or content of an avi file, or a keyword of related information of the name of an mp3 file or the name of the song, etc., it may be displayed as a keyword for search, and clicked by the user to initiate a search request.

At step S512, the search engine interface selected by the user is received, and an http search request of the keyword is generated.

At step S514, the http search request is sent to a search engine server.

At step S516, the returned http result is loaded in a popup window or a page floating layer of the browser for use by the user.

FIG. 6 is an effect drawing in which a search result is exhibited in a floating layer in a method for performing network search at a browser side according to an embodiment of the invention. Such a display method facilitates the user to quickly obtain the search result, and does not affect the user's browsing the original page, which achieves that the user is let to rapidly reach the content and acquire the search result quickly and accurately, and improves the efficiency of a search operation performed by the user when browsing a webpage.

When applying the technical solution of the embodiment, since a webpage element is acquired for which a search operation needs to be performed, and a search type and a keyword are determined according to the webpage element, the search result displayed in the browser matches the webpage element type, the result obtained by a user more meets search expectations, intervention of the search procedure by the user is reduced, and the efficiency of the search operation performed by the user when browsing a webpage is improved.

Further, an exhibition floating layer classified according to the search type is generated in the page, and the search result is loaded in the floating layer, which can perform display according to an accurate classification, facilitates the user to quickly obtain the search result, and does not affect the user's browsing the original page.

In the specification provided herein, a plenty of particular details are described. However, it can be appreciated that an embodiment of the invention may be practiced without these particular details. In some embodiments, well known methods, structures and technologies are not illustrated in detail so as not to obscure the understanding of the specification.

Similarly, it shall be appreciated that in order to simplify the disclosure and help the understanding of one or more of all the inventive aspects, in the above description of the exemplary embodiments of the invention, sometimes individual features of the invention are grouped together into a single embodiment, figure or the description thereof. However, the disclosed methods should not be construed as reflecting the following intention, namely, the claimed invention claims more features than those explicitly recited in each claim. More precisely, as reflected in the following claims, an aspect of the invention lies in being less than all the features of individual embodiments disclosed previously. Therefore, the claims complying with a particular implementation are hereby incorporated into the particular implementation, wherein each claim itself acts as an individual embodiment of the invention.

It may be appreciated to those skilled in the art that modules in a device in an embodiment may be changed adaptively and arranged in one or more device different from the embodiment. Modules or units or assemblies may be combined into one module or unit or assembly, and additionally, they may be divided into multiple sub-modules or sub-units or subassemblies. Except that at least some of such features and/or procedures or units are mutually exclusive, all the features disclosed in the specification (including the accompanying claims, abstract and drawings) and all the procedures or units of any method or device disclosed as such may be combined employing any combination. Unless explicitly stated otherwise, each feature disclosed in the specification (including the accompanying claims, abstract and drawings) may be replaced by an alternative feature providing an identical, equal or similar objective.

Furthermore, it can be appreciated to the skilled in the art that although some embodiments described herein comprise some features and not other features comprised in other embodiment, a combination of features of different embodiments is indicative of being within the scope of the invention and forming a different embodiment. For example, in the following claims, any one of the claimed embodiments may be used in any combination.

Embodiments of the individual components of the invention may be implemented in hardware, or in a software module running on one or more processors, or in a combination thereof. It will be appreciated by those skilled in the art that, in practice, some or all of the functions of some or all of the components in a browser according to individual embodiments of the invention may be realized using a microprocessor or a digital signal processor (DSP). The invention may also be implemented as a device or apparatus program (e.g., a computer program and a computer program product) for carrying out a part or all of the method as described herein. Such a program implementing the invention may be stored on a computer readable medium, or may be in the form of one or more signals. Such a signal may be obtained by downloading it from an Internet website, or provided on a carrier signal, or provided in any other form.

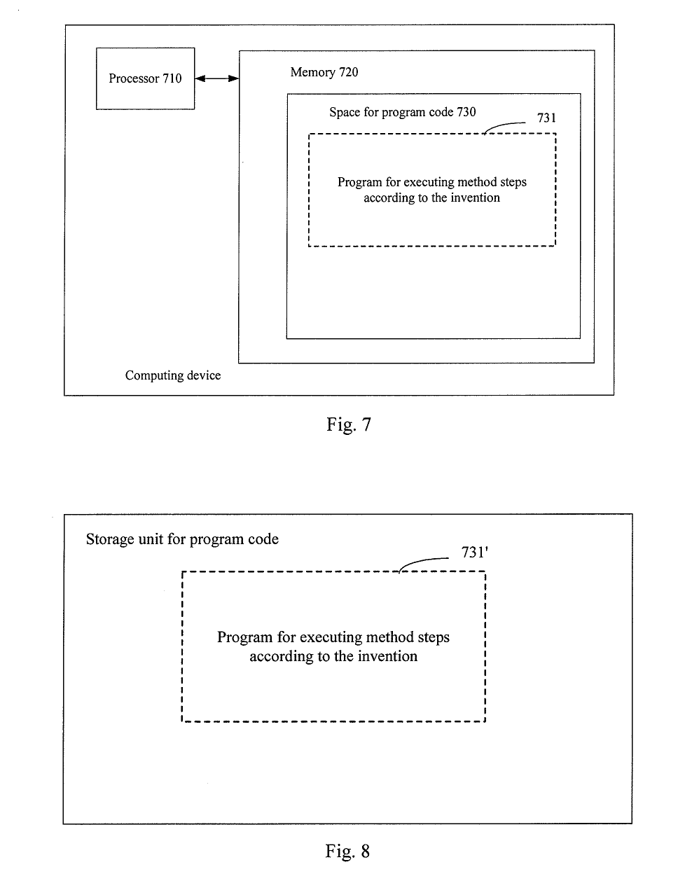

For example, FIG. 7 shows a computing device which may carry out a method for performing network search at a browser side according to the invention, for example, an application server, a personal computer, etc. The computing device traditionally comprises a processor 710 and a computer program product or a computer readable medium in the form of a memory 720. The memory 720 may be an electronic memory such as a flash memory, an EEPROM (electrically erasable programmable read-only memory), an EPROM, a hard disk or a ROM. The memory 720 has a memory space 730 for a program code 731 for carrying out any method steps in the methods as described above. For example, the memory space 730 for a program code may comprise individual program codes 731 for carrying out individual steps in the above methods, respectively. The program codes may be read out from or written to one or more computer program products. These computer program products comprise such a program code carrier as a hard disk, a compact disk (CD), a memory card or a floppy disk. Such a computer program product is generally a portable or stationary storage unit as described with reference to FIG. 8. The storage unit may have a memory segment, a memory space, etc. arranged similarly to the memory 720 in the computing device of FIG. 7. The program code may for example be compressed in an appropriate form. In general, the storage unit comprises a computer readable code 731′, i.e., a code which may be read by e.g., a processor such as 710, and when run by a computing device, the codes cause the computing device to carry out individual steps in the methods described above.

“An embodiment”, “the embodiment” or “one or more embodiments” mentioned herein implies that a particular feature, structure or characteristic described in connection with an embodiment is included in at least one embodiment of the invention. In addition, it is to be noted that, examples of a phrase “in an embodiment” herein do not necessarily all refer to one and the same embodiment.

It is to be noted that the above embodiments illustrate rather than limit the invention, and those skilled in the art may design alternative embodiments without departing the scope of the appended claims. In the claims, any reference sign placed between the parentheses shall not be construed as limiting to a claim. The word “comprise” does not exclude the presence of an element or a step not listed in a claim. The word “a” or “an” preceding an element does not exclude the presence of a plurality of such elements. The invention may be implemented by means of a hardware comprising several distinct elements and by means of a suitably programmed computer. In a unit claim enumerating several apparatuses, several of the apparatuses may be embodied by one and the same hardware item. Use of the words first, second, and third, etc. does not mean any ordering. Such words may be construed as naming.

Furthermore, it is also to be noted that the language used in the description is selected mainly for the purpose of readability and teaching, but not selected for explaining or defining the subject matter of the invention. Therefore, for those of ordinary skills in the art, many modifications and variations are apparent without departing the scope and spirit of the appended claims. For the scope of the invention, the disclosure of the invention is illustrative, but not limiting, and the scope of the invention is defined by the appended claims.

1. A method for performing network search at a browser side, comprising:
acquiring in a current page a webpage element for which a search operation is to be performed;
determining a webpage element type of the webpage element and a search type corresponding to the webpage element type;
acquiring a search keyword of the webpage element; and
initiating a search request to a search engine corresponding to the search type according to the search keyword, and displaying a returned search result at the browser side.

2. The method as claimed in claim 1, wherein the determining a webpage element type of the webpage element comprises:
acquiring a hypertext markup language text corresponding to the webpage element; and
determining a type of the webpage element according to a uniform resource locator comprised in the hypertext markup language text.

3. The method as claimed in claim 2, wherein the determining a type of the webpage element according to a uniform resource locator comprised in the hypertext markup language text comprises:
searching for a filename extension comprised in the uniform resource locator; and
judging out the webpage element type by the filename extension.

4. The method as claimed in claim 2, wherein the acquiring a search keyword of the webpage element comprises: searching the hypertext markup language text for the description information of the webpage element as the search keyword; or extracting the description information of the webpage element as the search keyword by traversing DOM data nodes of the page.

5. The method as claimed in claim 1, wherein the determining a search type corresponding to the webpage element type comprises:
searching for one or more search type corresponding to the webpage element type from a preset mapping configuration table.

6. The method as claimed in claim 5, wherein there are multiple search types corresponding to the webpage element type,
the initiating a search request to a search engine corresponding to the search type according to the search keyword comprises: assigning weights to the multiple search types according to priority levels, and initiating a search request to multiple search engines corresponding to the search types according to the search keyword in the order of the weights, respectively; and
the displaying a returned search result at the browser side comprises: displaying search results returned by the multiple search engines at the browser side in the order of the weights.

7. The method as claimed in claim 1, wherein the displaying a returned search result at the browser side comprises:
generating in the page an exhibition floating layer classified according to the search type, and loading the search result in the floating layer.

8. The method as claimed in claim 1, wherein the acquiring in a current page a webpage element for which a search operation is to be performed comprises:
acquiring the webpage content selected by a user from the page, and obtaining from the selected webpage content the webpage element for which a search operation is to be performed.

9. The method as claimed in claim 1, wherein the webpage element type comprises any one or more of the following: video, picture, music, and word.

10. A device for performing network search at a browser side, comprising:
a memory having instructions stored thereon; and
at least one processor configured to execute the instructions to perform operations for performing network search at a browser side, the operations comprising:
acquiring in a current page a webpage element for which a search operation is to be performed;
determining a webpage element type of the webpage element and a search type corresponding to the webpage element type;
acquiring a search keyword of the webpage element; and
initiating a search request to a search engine corresponding to the search type according to the search keyword, and display displaying a returned search result at the browser side.

11. The device as claimed in claim 10, wherein the operation of determining a webpage element type of the webpage element and a search type corresponding to the webpage element type comprises: acquiring a hypertext markup language text corresponding to the webpage element; and determining a type of the webpage element according to a uniform resource locator comprised in the hypertext markup language text.

12. The device as claimed in claim 11, wherein the operation of acquiring a search keyword of the webpage element comprises: searching the hypertext markup language text for the description information of the webpage element as the search keyword; or extracting the description information of the webpage element as the search keyword by traversing DOM data nodes of the page.

13. The device as claimed in claim 10, wherein the operation of determining a webpage element type of the webpage element and a search type corresponding to the webpage element type comprises: searching for one or more search type corresponding to the webpage element type from a preset mapping configuration table.

14. The device as claimed in claim 13, wherein there are multiple search types corresponding to the webpage element type, and the operation of initiating a search request to a search engine corresponding to the search type according to the search keyword, and displaying a returned search result at the browser side comprises: assigning weights to the multiple search types according to priority levels, and initiating a search request to multiple search engines corresponding to the search types according to the search keyword in the order of the weights, respectively; and displaying search results returned by the multiple search engines at the browser side in the order of the weights.

15. The device as claimed in claim 10, wherein the operation of displaying a returned search result at the browser side comprises: generating in the page an exhibition floating layer classified according to the search type, and loading the search result in the floating layer.

16. The device as claimed in claim 10, wherein the operation of acquiring in a current page a webpage element for which a search operation is to be performed comprises: acquiring the webpage content selected by a user from the page, and obtaining from the selected webpage content the webpage element for which a search operation is to be performed.

17. (canceled)

18. A non-transitory computer readable medium having instructions stored thereon that, when executed by at least one processor, cause the at least one processor to perform operations for performing network search at a browser side, comprising:
acquiring in a current page a webpage element for which a search operation is to be performed;
determining a webpage element type of the webpage element and a search type corresponding to the webpage element type;
acquiring a search keyword of the webpage element; and
initiating a search request to a search engine corresponding to the search type according to the search keyword, and displaying a returned search result at the browser side.
